(19) United States
(12) Patent Application Publication
(10) Pub. No.: US 2010/0181907 A1
(43) Pub. Date: Jul. 22, 2010

(54) TANTALUM CARBIDE FILAMENT LAMP AND PROCESS FOR THE PRODUCTION THEREOF

(75) Inventors: Mathias Hubertus Johannes Van Rijswick, Eindhoven (NL); Adriaantje Pieternella Mouws-Van Rossum, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/664,094

(22) PCT Filed: Jun. 10, 2008
(86) PCT No.: PCT/IB2008/052284

§ 371 Date: Dec. 11, 2009

(30) Foreign Application Priority Data
Jun. 20, 2007 (EP) 07110665.2

(51) Int. Cl. H01K 1/10; H01K 3/22; H01K 3/12

(52) U.S. Cl. 313/578; 445/38; 445/43

(57) ABSTRACT

The invention provides a filament lamp (1) having a filament (20), wherein the filament comprises tantalum carbide. The filament lamp comprises a lamp base part filament construction (15) which comprises a lamp base part (10) with a base part (11) top and a coil (21) comprising tantalum carbide connected to lead-in connections (23), the lead-in connections extending through the base part. The filament lamp further comprises a lamp bulb (40) connected to the base part top (11), thereby providing a filament enclosure (44), which filament enclosure comprises a gas filling (45). The invention further provides a process for making such a lamp.

### FIELD OF THE INVENTION

The present invention relates to a filament lamp comprising a tantalum carbide filament and to a production process for the production of such a lamp.

### BACKGROUND OF THE INVENTION

Filament lamps comprising tungsten or tantalum carbide filaments are known in the art. Already early in the 20^{th} century and especially in the 1950s and 1960s lamps having TaC coils were described.

For instance, GB 1144374 describes an electric incandescent lamp containing a filament made of a carbide of one of the metals tantalum, zirconium and hafnium or of a composite carbide of two or three of these metals, at least a part of the surface of the filament being coated with carbon. The filament may be made by heating a coil of wire made from the appropriate metal or alloy to a black body temperature of between 2000 and 2100° C. in a continuous flow of methane, ethane or propane until carburization has been completed, and then reducing the temperature to 1600-1700° C. and increasing the pressure to deposit a layer of carbon. The filament is heated by passing an alternating current through it, and deposition of carbon on parts of the filament can be prevented by shielding these parts with a negatively biased grid or a plate of mica. The thickness of the carbon layer can be varied over the surface of the filament by suitably directing the flow of gas. The filament is mounted in a lamp bulb by screwing its ends on to molybdenum mandrels welded to tungsten lead-in connections, and the bulb contains a reactive transport gas such as fluorine, chlorine, bromine, iodine, hydrogen or nitrogen, together with a catalyst, if required. In the preferred embodiment the bulb contains argon with a small quantity of hydrogen.

U.S. Pat. No. 3,287,591 addresses the production process for tantalum carbide incandescent lamps and indicates that because of the brittleness of the carbide, the tantalum metal coil has to be mounted in a lamp bulb or on a lamp stem before being carburized. It further mentions that it is impossible to simultaneously place a plurality of the lamps or lamp stems, on which the metal coil is mounted, in a carburizing furnace, because the lamps and stems are usually of glass, which would melt long before the carburizing temperature was reached. A further difficulty is that handling the brittle filament after it is carburized, and any attempt to attach it to lead-in and support wires in a lamp at a stage in the process, is likely to destroy the brittle coil entirely.

U.S. Pat. No. 2,596,469 describes a process for the production of tantalum carbide filament electric lamps comprising the steps of positioning a filament formed essentially of metallic tantalum in a lamp envelope containing an atmosphere comprising a volatile hydrocarbon and hydrogen, operating the filament within the atmosphere at a filament temperature of the order of 2800 K for a short period and gradually increasing the filament temperature to about 3600 K, whereby the filament is converted to tantalum carbide, and this conversion takes place within the sealed envelope of the lamp.

In general, W filament lamps were applied in the past. In recent times, the interest in TaC lamps (or other non-W filament lamps) has increased. For instance WO 2006/007815 describes a light bulb comprising an illumination body which is inserted, together with a filler material, into a bulb in a vacuum-tight manner. The illumination body has a metal carbide, whose melting point lies above that of tungsten. The current supply is configured so as to be in two parts: a first section and a second section. The first section is configured integrally with the illumination body and consists of a wire, and the second section, which functions as the actual current supply, is produced from a highly heat-resistant material.

The advantage of using metal carbide, whose melting point lies above that of tungsten, is that higher filament temperatures can be reached, which shifts the radiation distribution to shorter wavelengths, resulting in a higher luminous efficacy, and produces white light with higher color temperatures (“cooler light”).

### SUMMARY OF THE INVENTION

The production process of those prior art lamps, as far as disclosed in those prior art documents, has at least the drawback that it is relatively complicated, and especially the step of converting Ta to tantalum carbide may take a relatively long time. Especially the “in situ” generation of the tantalum carbide filament is a time-consuming step, whereas other “ex situ” processes are generally complicated. Herein, “in situ” means the carburization step within the bulb, such as for instance described in U.S. Pat. No. 2,596,469, and “ex situ” means carburization external to the bulb.

It is therefore an object of the invention to provide an alternative production process for the production of tantalum carbide filament lamps, which preferably further obviates one or more of the above-described drawbacks. It is a specific aspect to provide an alternative production process that is relatively quick and/or that may for instance relatively easily be performed batch wise. It is a further aspect of the invention to provide an alternative tantalum carbide filament lamp.

In a specific embodiment, it is an object of the invention to provide a process for the production of a filament lamp having a filament, wherein the filament comprises tantalum carbide, the process comprising:
a. providing a lamp base part filament construction comprising a lamp base part with a base part top, a coil connected to lead-in connections, the lead-in connections extending through the base part and the coil comprising tantalum;
b. converting at least part of the tantalum of the coil into tantalum carbide;
c. providing a lamp bulb with a bulb opening and bulb opening edge and connecting the bulb opening edge to the base part top, thereby providing a filament enclosure; and
d. introducing a gas filling into the filament enclosure.

Advantageously, such an alternative process is capable of relatively easily providing filament lamps with tantalum carbide filaments. Moreover, this process advantageously allows scaling up of the production process, since simultaneously, a large number of Ta coils can be converted (in one reactor) into tantalum carbide coils or filaments. Such a process is beneficially executed (batch wise) in a reactor; the conversion process may typically take about 5-20 minutes. Hence, the process of the invention provides a filament lamp in an alternative and especially advantageous way. Further, handling of the coil, i.e. of the lamp base part filament construction, is relatively easy compared with handling of the (brittle) coil alone.

The term “filament lamp” is known to the person skilled in the art. Such lamps are also indicated in the art as “incandescent lamps” or “electric incandescent lamps” or “filament electric lamps”. Herein, the term “filament” especially refers to the construction parts or elements of incandescent lamps that comprise coils or coiled structures, which, due to a flowing current during use of the lamp, transmit light in the visible portion of the spectrum. Such heated filaments are sometimes also indicated as black body radiators. With increasing filament temperature, the Planck distribution shifts to shorter wavelengths, resulting in relatively more radiation in the visible range and a relatively larger fraction of radiation in the blue compared to the yellow-red range, so that the color temperature increases (“cold white light”).

In a specific embodiment, the invention provides a process wherein “converting at least part of the tantalum of the coil into tantalum carbide” comprises introducing the lamp base part filament construction into a reactor, and heating the coil to a temperature in the range of about 2100-2900 K, especially in the range of about 2200-2800 K, in the presence of a hydrocarbon-containing gas. In a specific embodiment, the coil can be heated by passing a current through the coil. In this way, in an embodiment, the coil can be heated to the desired temperature in an easy and controlled manner. The hydrocarbon-containing gas can be any hydrocarbon that is gaseous, especially at temperatures of about 273 K and higher, such as one or more hydrocarbons selected from the group consisting of methane, ethane, propane, butane and isomers thereof The hydrocarbon-containing gas may further comprise a support gas such as argon or xenon. For instance, the hydrocarbon-containing gas for converting the tantalum of the coil into tantalum carbide may consist of argon with about 0.1-10 vol. % hydrocarbon gas, especially one of the above mentioned hydrocarbons, especially methane.

Herein, tantalum carbide especially refers to reaction products of tantalum (metal) and carbon (carburization product). Tantalum carbide may refer to pure TaC but may, in an embodiment, also include Ta₂C. Also intermediate compounds and compositions, i.e. compounds and compositions comprising TaₓC, wherein x is selected in the range of about 0.9-2.1, especially about 1-2, are included in an embodiment. Combinations of two or more different tantalum carbide compounds are also included, such as Ta₂C and TaC. In a specific embodiment, tantalum carbide substantially comprises TaC, especially more than about 99 wt. % of the tantalum carbide comprises TaC, more especially about 100 wt. % of the tantalum carbide comprises TaC. In another embodiment, tantalum carbide comprises an alloy of tantalum carbide and one or more of hafnium carbide and zirconium carbide, wherein the amount of tantalum carbide is at least about 50 wt. %, especially at least about 80 wt. %, relative to the total amount of the alloy.

The lamp base part filament construction, also indicated as “base part filament construction”, comprises a lamp base part (herein also indicated as “base part”) and a coil, connected to lead-in connections which extend through the base part. In an embodiment, the lead-in connections may be tantalum carbide, but in another embodiment, they comprise another material, such as for instance rhenium, molybdenum or nickel. The lead-in connections may comprise one or more parts, and may for instance comprise one or more materials selected from the group consisting of (molybdenum) foils or wires, (rhenium) wires, etc. as known in the art.

In particular, the part of the lead-in which is arranged within the filament enclosure (herein also indicated as “enclosure”) comprises rhenium. In a further variant, at least part of said part of the lead-in arranged within the base part comprises molybdenum. An advantage of choosing rhenium in the former embodiment is its relative resistivity against the gas filling (especially at working conditions); an advantage of choosing molybdenum in the latter embodiment is its relative compatibility with the thermal expansion coefficient of for instance hard glass and quartz.

The base part may for instance comprise, or in a variant consist of, a material selected from the group consisting of glass, especially hard glass, quartz and a ceramic material. In a specific embodiment, the base part comprises quartz. The lead-in connections extend through the base part, and have a part directed at the base part bottom (for connection to a voltage source) and a part directed at the base part top. As regards the latter part, the lead-in connections are connected to the filament (i.e. the coil is connected to the lead-in connections, at the base part top side).

Such a bulb may have any shape known in the art, and has at least one opening, which is arranged to enable the bulb to be slid over the filament (after conversion of tantalum into tantalum carbide) and to be connected to the base part. The opening has an edge, which is indicated as bulb opening edge. The bulb may have a second opening, in general substantially opposite the previously described bulb opening, which second opening may be the opening to a pump stem (vide infra)

As will be clear to the person skilled in the art, the dimensions of the base part and of the bulb opening will be selected to allow attachment of the base part top to the bulb opening. For instance, the base part may have a circular top with a first diameter and the bulb opening (or bulb opening edge) may be circular with a second diameter, such that, in an embodiment, the first diameter is larger than the second diameter, or, in an embodiment, these diameters are substantially equal. Hence, the base part and bulb dimensions are selected to provide an enclosure (not taking into account temporary openings in pump stems). In yet another embodiment, the dimensions of the base part and of the bulb opening are selected to allow at least part of the base part (especially the base part top) to be circumferentially enclosed by the bulb opening. In this embodiment, at least part of the base part, especially part of the base part top, has dimensions that are selected to allow the bulb opening to enclose it. For instance, a diameter of the bulb opening may be slightly larger than a diameter of part of the base part, thereby allowing the bulb opening to slide over at least part of the base part. In this way, a kind of plug (base part; especially base part top)—socket (bulb) construction is obtained. Other embodiments of attachments or connections than described herein may also be possible.

Said top side is the side to which also the bulb is connected or attached. In an embodiment of the process of the invention, “connecting the bulb opening edge to the base part top” comprises sealing the lamp base part and the bulb opening edge together with a seal, especially a gastight seal.

In an embodiment, such a seal comprises oxide-based materials that are heated to a temperature such that a tight seal is formed by sintering of the oxides, i.e. such a seal is obtainable by sintering a ceramic sealing composition. Such seals are also known as “ceramic sealing”, “ceramic seal”, “ceramic sealing frit”, etc., and may provide a kind of glassy glue or attachment between two parts, here the (top of the) base part and the (edge of the) bulb opening. In this embodiment, the seal may be another material than the material of the base part and/or the bulb.

In another embodiment, connecting the bulb opening edge to the base part top comprises sealing the lamp base part and the bulb opening edge by heating, such as laser heating. This variant may especially be applied when the bulb and the base part comprise or, in a variant, consist of substantially the same material, especially when these comprise or consist of quartz glass (“quartz”) or hard glass. In this way, the two parts are melted together (here, the seal is not substantially another material than the material of the base part and/or the bulb). Laser heating can be done by irradiating with laser light the bulb opening edge and/or the base part top close to the interface of the base part (top) and the bulb (edge). The glass or quartz (locally) melts and forms a sealing, especially a gastight seal, between base part and bulb.

Herein, the term “gastight seal” especially refers to seals and sealing materials that are capable of providing seals that, after sealing and filling the bulb with the gas filling, substantially do not allow the gas filling to escape through the seal and/or substantially do not let air penetrate into the bulb. Hence, in a specific embodiment, the lamp base part, especially the base part top, and the bulb, especially the bulb opening edge, and their dimensions, are chosen to allow sealing together the lamp base part and the bulb, such as by laser sealing or by sealing together using a ceramic seal (ceramic sealing material)(by sintering). Hence, the internal surface of the envelope is formed by (part of) the lamp base part top, a seal and the internal surface of the bulb. In an embodiment, this internal surface of the enclosure, or especially the wall of the enclosure, comprises or essentially consists of quartz. In another embodiment, the internal surface of the enclosure, or especially the wall of the enclosure, comprises or essentially consists of hard glass.

The gas filling may be provided in a number of ways. In a specific embodiment, known from related processes, the process of the invention may further comprise providing the gas filling via a pump stem attached to the lamp bulb. Such a pump stem is in general attached to the bulb before the bulb is attached to the base part. After (sealing the bulb to the base part and after) introduction of the gas filling into the enclosure formed by the base part and the bulb, the opening to the pump stem is closed by melting the glass (or quartz) of the pump stem and bulb and, in general, removing the remaining part of the pump stem. This may lead to the characteristic melting feature (“top”), such as also known in conventional incandescent lamps with halogen fillings, such as for instance displayed in the Figures of WO 2006/007815.

Alternatively, a bulb having only the bulb opening is provided, i.e. without a pump stem attached to or integrated in the bulb; and, in an embodiment, the process of the invention further comprises providing the gas filling via a pump stem into the base part.

Again, after providing the gas filling into the enclosure, the enclosure is closed, in this embodiment by for instance melting the pump stem or sealing the pump stem such that a seal, especially a gastight seal, is obtained (vide supra). Such a filling process may for instance be applied in embodiments wherein the base part comprises a plate, such as for instance described in WO 98/50943. Such a plate may comprise a pump stem.

In an embodiment, the gas filling comprises a noble gas, such as krypton or xenon, and especially also additives. The pressure within the bulb is, in a specific embodiment, in the range of about 0.5-15 bar, especially in the range of about 3-10 bar.

The additive may especially comprise compounds comprising one or more atoms selected from the group consisting of C, H, O, N and halogens. In an embodiment, especially all of these atoms are represented in one or more compounds of the gas filling, such as a gas filling comprising Kr, H₂, N₂ and CH₂Br₂.

The additive is gaseous especially at room temperature in the above described pressure ranges.

In a specific embodiment, the additive comprises a hydrocarbon and a halogen-containing compound. The halogen-containing compound may comprise one or more compounds selected from the group consisting of halogen gasses, hydrogen halides and halogenated hydrocarbons. In a specific embodiment, the gas filling comprises a noble gas and an additive, the additive comprising a hydrocarbon (including, in an embodiment, a halogenated hydrocarbon). In a specific embodiment, the additive comprises a compound comprising C, H and X (where X is a halogen), such as CH₂Br₂. In a more specific embodiment, the additive comprises H₂ and compounds comprising one or more atoms selected from the group consisting of C and halogens.

In general, also N₂ is comprised in the gas. In a specific embodiment, the gas filling comprises a noble gas, a halogenated hydrocarbon and one or more of H₂ and N₂. In another specific embodiment, the gas filling comprises a noble gas, a hydrocarbon, one or more of a halogen gas (such as Br₂, I₂, etc.) and a hydrogen halide (such as HBr, HCI, etc.) and one or more of H₂ and N₂. In yet a further specific embodiment, the gas filling comprises a noble gas, a halogenated hydrocarbon, N₂ and H₂. The total amount of additive is in general in the range of about 0.1-10 vol. %.

In an embodiment, additives may be selected from the group consisting of hydrogen H₂, Br₂, Cl₂, I₂, hydrocarbons (such as CH₄, C₂H₆, C₂H₄, C₂H₂), HBr, HCl, HI, one or more halogenated hydrocarbons (such as one or more selected from the group consisting of halogenated methane, ethane, propane (such as one or more selected from the group consisting of CH₂Br₂, CHBr₃, CH₃Br, CH₂Cl₂, CHCl₃, CH₃Cl, and CH₃I) and one or more sulphide compounds (such as compounds selected from the group consisting of H₂S, CS₂, CH₃SH, C₂H₅SH and CH₃CSCH₃).

After filling the enclosure with the gas filling, the enclosure is closed by closing the opening arranged to provide the gas filling into the enclosure. Hence, the term “providing a gas filling into the filament enclosure” includes, in an embodiment, the closing of the filament enclosure. As described above, this in general includes the closing/sealing of a pump stem.

According to a further aspect, the invention provides a filament lamp obtainable by the process according to the invention, as described herein.

In a specific aspect, the invention provides a filament lamp having a filament comprising tantalum carbide, the filament lamp comprising a lamp base part filament construction comprising a lamp base part with a base part top, a coil comprising tantalum carbide connected to lead-in connections, which lead-in connections are arranged to extend through the base part, and a lamp bulb connected to the base part top, thereby providing a filament enclosure, the filament enclosure containing a gas filling comprising a noble gas.

Advantageously, such a lamp may have (during use) a better efficacy than W lamps and a higher color temperature.

In a specific embodiment, the filament lamp with a tantalum carbide coil comprises a lamp base part and a bulb which comprise quartz. Hence, in a specific embodiment, a tantalum carbide filament lamp is provided, wherein the filament enclosure has a wall which comprises or, in an aspect, consists of quartz. Hence, in an embodiment, the base part and lamp bulb of the filament lamp of the invention comprise quartz. In another embodiment, the base part and lamp bulb comprise hard glass. The filament lamp further comprises a seal arranged to interconnect the bulb and the lamp base part, which is obtainable, in an embodiment, by melting together the bulb opening edge and the base part top, or, in another embodiment, the filament lamp comprises a ceramic seal (connecting the bulb opening edge and the base part top). Herein, the phrase “lamp bulb connected to the base part top” refers to a lamp bulb sealed to the base part top. In this way, the lamp bulb and the base part top are attached to each other by means of a seal (which, in an embodiment, may comprise a sintered ceramic sealing material or which, in another embodiment, may be obtainable by melting the lamp bulb to the base part top, for instance by laser heating). In another specific embodiment, the base part comprises a pinched base part, i.e., in an embodiment, the lead-ins are contained in for instance a pinched tube of quartz or hard glass. The term “pinched” herein refers to a base part of which at least part is pinched; therefore, the lead-ins are at least partly integrated in the base part.

In another specific embodiment, the lead-in comprises at least two parts, the interface of the first and the second part being arranged within the base part. In a variant thereof, the part of the lead-in extending from the bottom comprises molybdenum (Mo) or tungsten (W), especially molybdenum, and the part of the lead-in extending from the base part top comprises rhenium (Re), osmium (Os), iridium (Ir) or ruthenium (Ru), especially rhenium.

### BRIEF DESCRIPTION OF THE DRAWINGS

Embodiments of the invention will now be described, by way of example only, with reference to the accompanying schematic drawings in which corresponding reference symbols indicate corresponding parts:

FIGS. 1a-1b schematically depict an embodiment of a lamp base part filament construction in a reactor and an embodiment of the finished lamp, respectively;

FIGS. 2a-2d schematically depict a number of details of variants of embodiments described herein with respect to the base part and the bulb; and

FIGS. 3a-3b schematically depict another embodiment of a lamp base part filament construction in a reactor and another embodiment of the finished lamp, respectively.

### DETAILED DESCRIPTION OF THE EMBODIMENTS

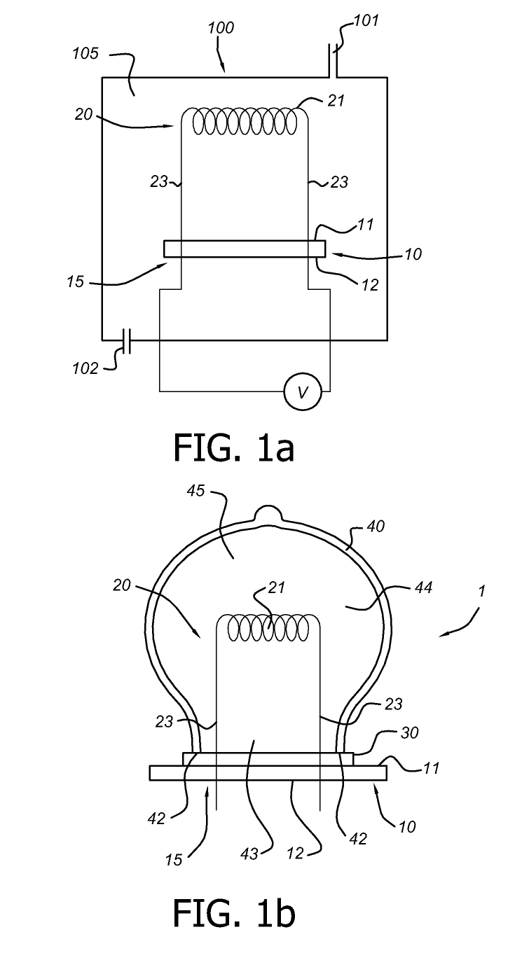

FIGS. 1a and 1b schematically depict some stages in the process for the production of the filament lamp according to the invention.

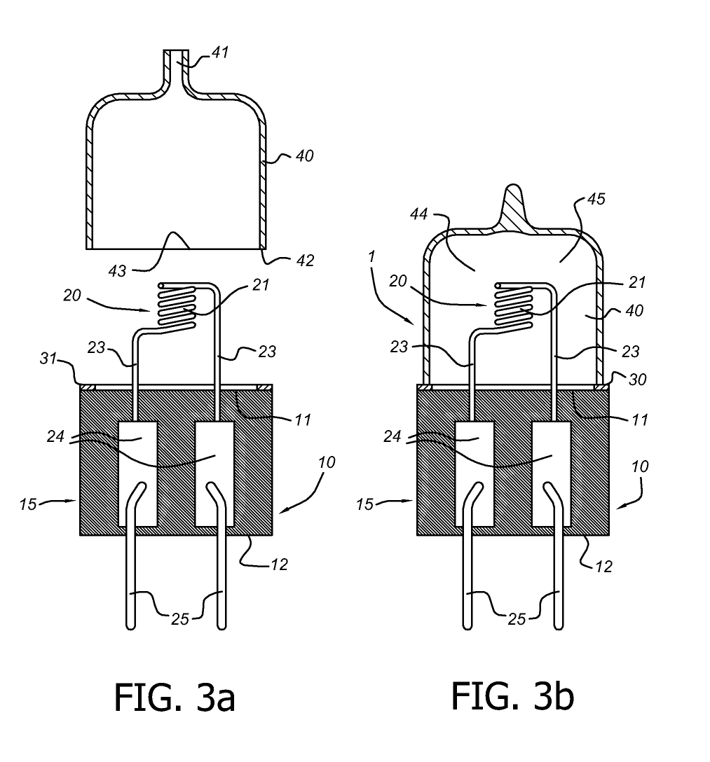

FIG. 1a schematically depicts a lamp base part filament construction 15 comprising a lamp base part 10 with a base part top 11 and a base part bottom 12, a coil 21 connected to lead-in connections 23, which lead-in connections 23 extend through the base part 10 and the coil 21 comprises tantalum (Ta). The coil 21 is also indicated as filament 20. In this schematic Figure, the lamp base part 10 is depicted as a plate or disc; however, the invention is not limited to such embodiments. For instance, lamp base part 10 may also comprise a pinched base part (see for instance FIGS. 3a-b). Further, the lamp base part 10 used herein is schematically depicted in a reactor 100 with inlet 101. Through inlet 101, the desired gasses 105 can be introduced into the reactor 100, especially the hydrocarbon containing gasses for converting tantalum into tantalum carbide. This conversion may be performed at elevated temperatures, which can be obtained by applying a voltage source to the lead-ins 23 and generating a current through the coil 21. In this way, at least part of the tantalum of the coil 21, especially of substantially the entire coil 21, is converted into tantalum carbide. Gas may be removed from reactor 100 via an outlet 102.

After this conversion, a finished lamp filament lamp 1 according to the invention is provided, see schematic FIG. 1a, by providing (“sliding”) a bulb 40 over the filament 20 and attaching this bulb 40 to the base part 10. The lamp bulb 40 with bulb opening 43 has a bulb opening edge 42, and the bulb opening edge 42 is sealed to the base part top 11. In this way, filament enclosure 44 is created.

In the schematic embodiment of FIG. 1b, the lamp 1 comprises a seal 30, which may in this embodiment be a seal based on a ceramic sealing or ceramic sealing frit 30. Such ceramic sealing materials are heated and, by sintering, a sealing 30 is formed with tightly interconnects the bulb edge 42 and the top 11 of the base part. Such seals are known in the art and can be provided as gastight seals. Seal 30 can also be understood as a zone between bulb 40 and base part 10, especially between edge 42 and top 11, which is obtainable by melting together bulb 40 and base part 10, for instance by laser heating. State of the art lamps based on W coils and pinched base parts 10, do not comprise seal 30 arranged between coil 21 and base part 10.

Further, a gas filling 45 is introduced into the filament enclosure 44. Such a gas, as mentioned above, comprises a noble gas and in general also additives, such as gaseous compounds comprising one or more atoms selected from the group consisting of C, H, O, N and halogens, such as Kr, a mixture of CH₂Br₂ and CH₂Cl₂, H₂ and N₂. Characteristic pressures are in the range of about 0.5-15 bar, especially in the range of about 3-10 bar. A characteristic gas composition is for instance Kr with 0.1% CH₂Br₂+0.1% CH₂Cl₂+0.5% H₂+0.5% N₂+0.05% O₂. In an embodiment, the gas filling 45 may be introduced through a pump stem, which may be attached to the bulb 40 and/or which may be attached to the base part 10. The term “attached to” may also refer to “integrated in”. Suitable gasses and combinations of gasses are for instance described in U.S. Pat. No. 3,022,438 and US 2006/0103305, which are incorporated herein by reference. After providing the gas filling 45 to the filament enclosure 44, the filament enclosure 44 is finally closed by melting together the pump stem 41 (or 13, see below), i.e. closing the opening in the pump stem. Thereby, a gastight filament enclosure 44 is obtained.

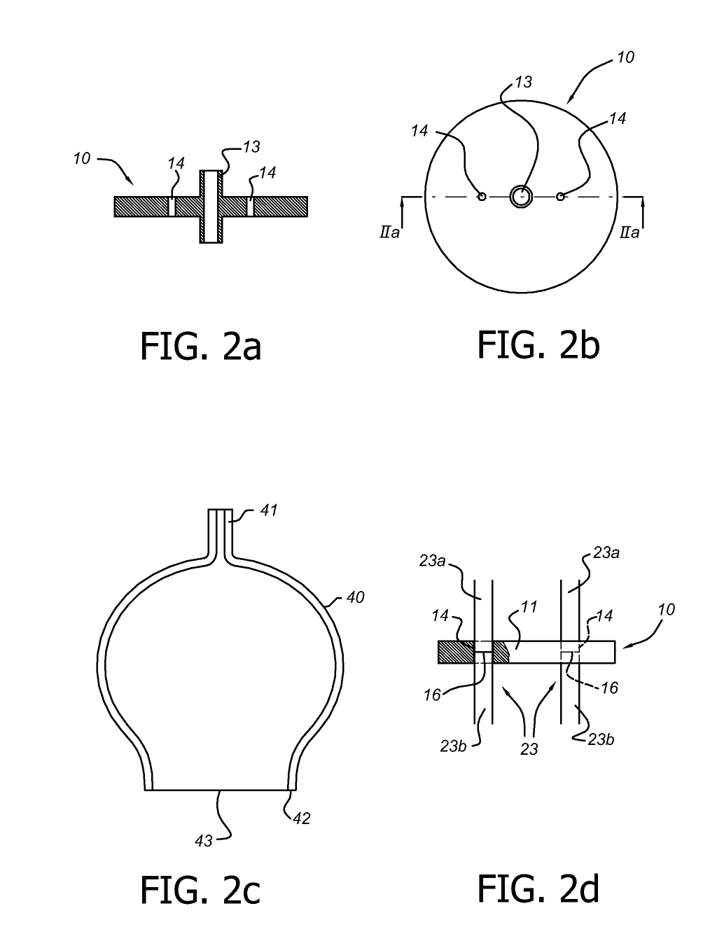

FIGS. 2a-2d schematically depict a number of details of variants of the embodiments described herein of lamp 1 of the invention.

FIG. 2a schematically depicts a side view of an embodiment base part 10, wherein the base part 10 comprises two openings 14 arranged to receive lead-ins 23 and an opening or stem 13, which can be used to introduce gas 45 into enclosure 44. FIG. 2b schematically depicts a top view of such a variant of base part 10, wherein the openings 14 and the opening of the optional stem 13 are indicated. The embodiments schematically depicted in FIGS. 2a and 2b refer to substantially circular base plates.

FIG. 2c schematically depicts an embodiment of bulb 40, comprising bulb opening 43 and opening edge 42 and gas stem 41. This stem 41 can (alternatively) be used to introduce gas 45 into enclosure 44. After introducing gas 45, part of gas stem 41 is removed and the opening in the bulb at stem 41 is sealed, leading to the well known and characteristic top of bulbs filled with gas in this way.

After sealing the bulb 40 to the bottom part 10 and closing (sealing) the gas stem 41 or alternatively stem 13, a gastight enclosure 44 is obtained.

FIG. 2d schematically depicts a specific embodiment of lead-ins 23. Lead-ins 23 in this variant comprise at least two parts, indicated as first part 23a and second part 23b. The lead-ins extend through (i.e. penetrate through) base part 10. In particular, the first part 23a of the lead-in 23, which is arranged within the filament enclosure 44, i.e. the first part 23a which is at least partially arranged at the top side 11 of the base part 10, comprises, in an embodiment, rhenium (or in another embodiment Os, or Ir or Ru). In particular, the second part 23b of the lead-in 23, which is arranged outside the filament enclosure 44, i.e. the second part 23b which is at least partially arranged at bottom side 12 of the base part 10, comprises, in an embodiment, molybdenum (or W). In a specific variant, at least a part of the part of the lead-in 23 arranged within the base part 10 comprises molybdenum. In a specific embodiment, as depicted herein, the interface 16 of the two parts 23a and 23b is especially arranged within the holes 14 for the lead-ins 23. As mentioned above, an advantage of choosing rhenium is its relative resistivity to the gas filling 45 (especially at working conditions); an advantage of choosing molybdenum is its relative compatibility with the thermal expansion coefficient of for instance hard glass and quartz, when such materials are chosen as the material for the base part 10.

FIGS. 3a and 3b schematically depict a variant of the embodiments schematically depicted in FIGS. 1a and 1b. Here, base part 10 is a base similar to known bases for halogen lamps (based on W), and includes lead-ins 23 which further comprise molybdenum foils or wires 24, substantially arranged within the base part 10, and electric contacts 25, which extend from the bottom side 12 of the base part 10. Such base parts 10 are pinched. Pinching is known in the art for W-based halogen lamps. As can be seen from the drawings, at least part of the base part 10 is pinched. The lead-ins 23 are at least partly integrated in the base part 10 and extend therefrom (on both sides of the base part 10). The dimensions of the base part 10, especially top 11 and bulb 40, more particularly bulb opening 43 (and edge 42), are especially selected to substantially fit each other and allow contact over the whole edge 42 with top 11 of base part 10. In another embodiment, not depicted, dimensions of the base part 10 and of the bulb opening 43 are selected to allow at least part of the base part 10 (especially the base part top 11) to be circumferentially enclosed by the bulb opening 43. In this embodiment, at least part of the base part 10, especially part of the base part top 11, has dimensions that are selected to allow the bulb opening 43 to enclose it. For instance, a diameter of the bulb opening 43 may be slightly larger than a diameter of part of the base part 10, thereby allowing the bulb opening 43 to slide over at least part of the base part 10. In this way, a kind of plug (base part 10; especially base part top 11)—socket (bulb 40) construction is obtained. Other embodiments of attachments or connections than described herein may also be possible.

The parts between molybdenum plates 24 and coil 21 may comprise rhenium. The material of coil 21 again comprises tantalum before carburization and tantalum carbide after carburization. After carburization, the base part filament construction 15 and bulb 40 are brought into contact which each other and, in an embodiment, are sealed together, especially such that a gastight seal 30 is obtained. By way of example, in FIG. 3a an elevation 31 is schematically drawn, which, in an embodiment, may be a ceramic sealing material (sealing frit), which may be in the form of a ring (frit ring). Due to heating of the sealing material, bulb 40 and base part 10 can be sealed together, thereby forming seal 30. In another embodiment, elevation 31 may for instance be an elevation integrated with base part 10 (a rim), arranged to be attached to edge 42 of bulb 40, and arranged to be melted together with edge 42, for instance by laser heating, thereby (also) forming seal 30.

In the embodiment schematically depicted in FIG. 3b, both base 10 material and bulb 40 material may substantially be the same material, such as hard glass, or quartz. These parts may be sealed by a sealing process with a laser which melts the hard glass or quartz at the interface of edge 42 and top 11, or by a sealing process using a ceramic sealing material, thereby providing a seal 30, especially a gastight seal. Then, the gas filling 45 is introduced via gas stem 41 and, after reaching the desired gas filling, the stem opening is melted to close the filament enclosure 44. Thereby, a gastight filament enclosure 44 is obtained.

The lamp 1 of the invention is especially suitable as halogen low voltage lamp, for instance in the range of 6-50 V, such as 12V lamps.

The term “hard glass” especially refers to alkaline earth alumino silicate glasses, alumino boro silicate glasses and alumino silicate glasses. Another example of hard glass is Vycor. The term “quartz” particularly refers to fused quartz. The term “hard glass” is known in the art.

In an embodiment, instead of tantalum carbide, another carbide is used, or an alloy of carbides is used. Hence, in a specific embodiment, as the coil material (in the finished lamp) use is made of a material selected from the group consisting of tantalum carbide, zirconium carbide, hafnium carbide, and alloys of two or more of these carbides. Hence, in another specific embodiment, the coil 21 comprises a material selected from the group consisting of tantalum, zirconium, hafnium, and alloys of two or more of these materials, and the process comprises (b) converting at least part of the material of the coil 21 into material selected from the group consisting of tantalum carbide, zirconium carbide, hafnium carbide, and alloys of two or more of these carbides.

It should be noted that the terms “top” and “bottom”, and “left” and “right” are interchangeable, unless the contrary is indicated or clear from the description.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. In the device claim enumerating several means, several of these means may be embodied by one and the same item of hardware. The mere fact that certain measures are recited in mutually different dependent claims does not indicate that a combination of these measures cannot be used to advantage.

1. A process for the production of a filament lamp (1) having a filament (20), wherein the filament (20) comprises tantalum carbide, the process comprising:
a. providing a lamp base part filament construction (15) comprising a lamp base part (10) with a base part top (11), a coil (21) connected to lead-in connections (23), the lead-in connections (23) extending through the base part (10), and the coil (21) comprising tantalum;
b. converting at least part of the tantalum of the coil (21) into tantalum carbide;
c. providing a lamp bulb (40) with a bulb opening (43) and bulb opening edge (42) and connecting the bulb opening edge (42) to the base part (11), thereby providing a filament enclosure (44); and
d. introducing a gas filling (45) into the filament enclosure (44).

2. The process according to claim 1, wherein converting at least part of the tantalum of the coil (21) into tantalum carbide comprises introducing the lamp base part filament construction (15) into a reactor (100), and heating the coil (21) to a temperature in the range of 2200-2800 K in the presence of a hydrocarbon-containing gas.

3. The process according to claim 1, wherein connecting the bulb opening edge (42) to the base part top (11) comprises sealing the lamp base part (10) and the bulb opening edge (42) together by means of a seal (30).

4. The process according to claim 3, wherein the bulb (40) and the base part (10) comprise quartz glass, and wherein connecting the bulb opening edge (42) to the base part top (11) comprises sealing the lamp base part (10) and the bulb opening edge (42) together by laser heating.

5. The process according to claim 1, comprising providing the gas filling (45) via a pump stem (41) attached to the lamp bulb (40).

6. The process according to claim 1, comprising providing the gas filling (45) via a pump stem (13) in base part (10).

7. The process according to claim 1, wherein the gas filling (45) comprises a noble gas and an additive, and the additive comprises a hydrocarbon and a halogen-containing compound.

8. The process according to claim 1, wherein the gas filling (45) comprises a noble gas and a halogenated hydrocarbon.

9. The process according to claim 3, wherein the seal (30) comprises a ceramic seal.

10. A filament lamp (1) obtainable by the process according to claim 1.

11. A filament lamp (1) having a filament comprising tantalum carbide, the filament lamp (1) comprising
a lamp base part filament construction (15) comprising a lamp base part (10) with a base part top (11),
a coil (21) comprising tantalum carbide connected to lead-in connections (23), which lead-in connections (23) extend through the base part (10),
a lamp bulb (40) connected to the base part (11), thereby providing a filament enclosure (44), which filament enclosure (44) comprises a gas filling (45),
a seal arranged to interconnect the bulb and the lamp base part.

12. (canceled)

13. The filament lamp (1) according to claim 12, wherein the seal (30) comprises a ceramic seal.

14. The filament lamp (1) according to claim 10, wherein the base part (10) and lamp bulb (40) comprise quartz or hardglass.

15. (canceled)
